(19) United States
(12) Patent Application Publication
(10) Pub. No.: US 2026/0223143 A1
(43) Pub. Date: Jul. 30, 2026

(54) RESOURCE DETERMINATION METHOD AND APPARATUS, AND STORAGE MEDIUM

(71) Applicant: ZTE CORPORATION, Shenzhen, Guangdong (CN)

(72) Inventors: Haigang HE, Shenzhen (CN); Weimin XING, Shenzhen (CN); Youxiong LU, Shenzhen (CN); Jie CHEN, Shenzhen (CN)

(21) Appl. No.: 19/144,275

(22) PCT Filed: Jul. 4, 2024
(86) PCT No.: PCT/CN2024/103645

§ 371 Date: Jun. 27, 2025

(30) Foreign Application Priority Data
Jul. 28, 2023 (CN) 202310913017.X

(51) Int. Cl. H04W 72/40; H04W 72/0446

(52) U.S. Cl. CPC H04W 72/40; H04W 72/0446

(57) ABSTRACT

The present disclosure provides a resource determination method and apparatus, and a storage medium. The resource determination method includes, receiving a physical sidelink shared channel (PSSCH) in a resource pool; where the resource pool includes at least one resource block set in frequency domain, each resource block set of the at least one resource block set includes at least one sub-channel, and each sub-channel of the at least one sub-channel includes multiple resource blocks; determining a mapping relationship between sub-channels and physical sidelink feedback channel (PSFCH) resources, where the each sub-channel and a resource block corresponding to a PSFCH resource mapped to the subchannel are within a same resource block set; and determining a PSFCH resource mapped to at least one sub-channel included in the PSSCH based on the mapping relationship between the sub-channels and the PSFCH resources.

### CROSS-REFERENCE TO RELATED APPLICATION(S)

This application is a national phase entry under 35 USC 371 of International Patent Application No. PCT/CN2024/103645 filed on Jul. 4, 2024, the International Patent Application is filed based on Chinese Patent Application with the application No. 202310943017.X, filed on Jul. 28, 2023, and claims priority to the Chinese Patent Application, the entire contents of the International Patent Application and the Chinese Patent Application are incorporated herein by reference.

### TECHNICAL FIELD

The present disclosure relates to the field of communication technologies, and in particular, to a resource determination method and apparatus, and a storage medium.

### BACKGROUND

Sidelink communication is a mode of communication between communication devices directly, without the transmission by a core network. In this communication mode, data, control information and other assistance information may be exchanged directly between communication devices, which saves radio spectrum resources and reduces a data transmission pressure of the core network, which can reduce system resource occupation, increase spectrum efficiency of cellular communication systems, reduce communication delays, and save network operating costs to a great extent.

In the sidelink communication, a physical sidelink feedback channel (Physical Sidelink Feedback Channel, PSFCH) is used to transmit feedback information related to communication qualities, interference conditions, resource allocation, etc., between communication devices.

### SUMMARY

In an aspect, a resource determination method is provided, and performed by a first communication device. The resource determination method includes:
receiving a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
determining a mapping relationship between sub-channels and physical sidelink feedback channel (PSFCH) resources, where the each sub-channel and a resource block corresponding to a PSFCH resource mapped to the sub-channel are within a same resource block set; and
determining a PSFCH resource mapped to at least one sub-channel included in the PSSCH based on the mapping relationship between the sub-channels and the PSFCH resources.

In another aspect, a resource determination method is provided, and performed by a second communication device. The resource determination method includes:
sending a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
determining a mapping relationship between sub-channels and physical sidelink feedback channel (PSFCH) resources, where the each sub-channel and a resource block corresponding to a PSFCH resource mapped to the sub-channel are within a same resource block set; and
determining a PSFCH resource mapped to at least one sub-channel included in the PSSCH based on the mapping relationship between the sub-channels and the PSFCH resources.

In yet another aspect, a resource determination apparatus is provided, applied to a first communication device. The resource determination apparatus includes:
a communication module, configured to receive a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
a processing module, configured to determine a mapping relationship between sub-channels and physical sidelink feedback channel (PSFCH) resources, where the each sub-channel and a resource block corresponding to a PSFCH resource mapped to the sub-channel are within a same resource block set; and
the processing module, further configured to determine a PSFCH resource mapped to at least one sub-channel included in the PSSCH based on the mapping relationship between the sub-channels and the PSFCH resources.

In yet another aspect, a resource determination apparatus is provided, applied to a second communication device. The resource determination apparatus includes:
a communication module, configured to send a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
a processing module, configured to determine a mapping relationship between sub-channels and physical sidelink feedback channel (PSFCH) resources, where the each sub-channel and a resource block corresponding to a PSFCH resource mapped to the sub-channel are within a same resource block set; and
the processing module, further configured to determine a PSFCH resource mapped to at least one sub-channel included in the PSSCH based on the mapping relationship between the sub-channels and the PSFCH resources.

In yet another aspect, a communication apparatus is provided. The communication apparatus includes: a memory and a processor; the memory is coupled with the processor; the memory is configured to store computer program instructions executable by the processor; and the processor, when executing the computer program instructions, implements the resource determination method described in any one of the above aspects.

In yet another aspect, a computer readable storage medium is provided, and the computer readable storage medium has stored computer program instructions thereon, and the computer program instructions, when executed on a communication apparatus, implement the resource determination method described in any one of the above aspects.

In yet another aspect, a computer program product is provided, the computer program product includes computer program instructions, and the computer program instructions, when executed, implement the resource determination method described in any one of the above aspects.

### BRIEF DESCRIPTION OF THE DRAWINGS

FIG. 1 is a schematic diagram of an architecture of a communication system according to some embodiments of the present disclosure.

FIG. 2 is a flow chart of a resource determination method according to some embodiments of the present disclosure.

FIG. 3 is a diagram of a mapping relationship between sub-channels and PSFCH resources according to some embodiments of the present disclosure.

FIG. 4 is a diagram of another mapping relationship between sub-channels and PSFCH resources according to some embodiments of the present disclosure.

FIG. 5 is a diagram of yet another mapping relationship between sub-channels and PSFCH resources according to some embodiments of the present disclosure.

FIG. 6 is a diagram of an association relationship between a PSFCH slot/occasion and a PSSCH slot according to some embodiments of the present disclosure.

FIG. 7 is a flow diagram of a communication interaction according to some embodiments of the present disclosure.

FIG. 8 is a flow chart of another resource determination method according to some embodiments of the present disclosure.

FIG. 9 is a structural schematic diagram of a resource determination apparatus according to some embodiments of the present disclosure.

FIG. 10 is a structural schematic diagram of another resource determination apparatus according to some embodiments of the present disclosure.

FIG. 11 is a structural schematic diagram of a communication apparatus, according to some embodiments of the present disclosure.

### DETAILED DESCRIPTION

To enable those skilled in the art to better understand the technical solutions of the embodiments of the present disclosure, the technical solutions in the embodiments of the present disclosure clearly and completely will be described below, in conjunction with the drawings in the embodiments of the present disclosure. Obviously, the described embodiments are only a part of the embodiments of the present disclosure, not all of the embodiments. Based on the embodiments of the present disclosure, all other embodiments obtained by those ordinary skilled in the art without making inventive efforts fall within the scope of protection of the present disclosure.

In the description of the present disclosure, unless otherwise specified, the symbol “/” means “or”, and for example, A/B may represent A or B. Herein, “and/or” is only used to describe an associated relationship between associated objects, representing that there may be three relationships, and for example, A and/or B may represent three cases: only A, only B, and both A and B. Additionally, “at least one” means one or more, and “multiple/plurality of” means two or more. Words, such as “first” and “second”, etc., do not limit the quantity and execution order, and the words, such as “first” and “second”, etc., also do not necessarily limit different items.

It should be noted that in the present disclosure, the words such as “exemplary/exemplarily” or “for example (e.g.)”, etc., are used to present an example, illustration, or explanation. Any embodiment or design scheme described with “exemplary/exemplarily” or “for example” in the present disclosure should not be construed as preferred or advantageous over other embodiments or design schemes. Rather, the embodiments or design solutions using “exemplary/exemplarily” or “for example”, etc., should not be construed as preferred or advantageous over other embodiments or design solutions. Rather, the use of the words such as “exemplary/exemplarily” or “for example”, etc., is intended to present relevant concepts in a specific manner.

In a sidelink communication system, when there is a service to be transmitted between communication devices, the service between the communication devices does not pass through a network side, that is, it does not pass through the forwarding of a cellular link between the communication device and a base station, but is directly transmitted from a data source communication device to a target communication device by sidelink, and this mode of direct communication between a communication device and a communication device is significantly different from a feature of a communication mode of a traditional cellular system. Typical applications of the sidelink communication include device-to-device (Device-to-Device, D2D) communication and vehicle to everything (Vehicle to Everything, V2X) communication. V2X communication includes vehicle to vehicle (Vehicle to Vehicle, V2V), vehicle to pedestrian (Vehicle to Pedestrian, V2P), and vehicle to infrastructure (Vehicle to Infrastructure, V2I).

For short-distance communication devices that can apply the sidelink communication, the sidelink communication not only saves radio spectrum resources, but also reduces the data transmission pressure of a core network, which can reduce system resource occupancy, increase the spectrum efficiency of cellular communication systems, reduce communication delays, and save network operating costs to a great extent.

In the unlicensed spectrum, only a channel with a successful listen before talk (Listen Before Talk, LBT) can be transmitted. LBT means that a communication node needs to compete for a resource, and only when the competition for a time-frequency resource is successful, the communication node may transmit information on the time-frequency resource. More specifically, in an LBT mechanism, a communication node, before transmitting information, first listens to whether a channel is idle during performing a channel access process, and only when the listening indicates the channel is idle, the communication node may transmit the information.

In the sidelink communication, the physical sidelink shared channel (Physical Sidelink Shared Channel, PSSCH) is used to carry data of a communication device in the sidelink communication, and supports direct communication between communication devices. The PSSCH provides a high-speed and reliable data transmission at a physical layer. A plurality of communication devices may transmit respective PSSCHs at the same time. Each communication device transmits the PSSCH in one or more slots, and when a communication device transmits a PSSCH in a slot, it may retransmit the PSSCH or transmit another PSSCH in another slot. A PSSCH is transmitted by a communication device in a slot, and is transmitted through a plurality of sub-channels in the frequency domain, and a sub-channel includes one or more resource blocks.

The PSFCH is used to transmit feedback information related to communication qualities, interference conditions, resource allocation, etc., between communication devices. These feedback information may be used to optimize aspects, such as resource allocation/selection, beamforming and interference management, etc.

Currently, in the 3GPP standard, the determination of PSFCH resources mainly considers the determination of PSFCH resources under an intelligent transportation system (Intelligent Transportation System, ITS) spectrum and the licensed spectrum. However, there is no clear method for determining the PSFCH resource for a case where the unlicensed spectrum is used for the sidelink.

In view of this, the present disclosure provides a resource determination method, including: receiving a PSSCH in a resource pool, determining a mapping relationship between sub-channels and physical sidelink feedback channel (PSFCH) resource; and then determining a PSFCH resource mapped to at least one sub-channel contained in the PSSCH based on the mapping relationship between the sub-channels and the PSFCH resources, thereby solving the issue of determining the PSFCH resource under the unlicensed spectrum. A sub-channel and a resource block corresponding to a PSFCH resource mapped to the sub-channel are within a same resource block set, which is conducive to COT (Channel Occupy Time) sharing between communication devices and conducive for the communication device transmitting the PSFCH to obtain the right to use a time-frequency resource of the unlicensed spectrum.

The technical solutions provided in the embodiments of the present disclosure may be applied to various mobile communication networks, for example, new radio (New Radio, NR) mobile communication networks using the fifth generation mobile communication technology (5th generation mobile networks, 5G), future mobile communication networks or multiple communication technology fusion systems, etc., which are not limited to the embodiments of the present disclosure.

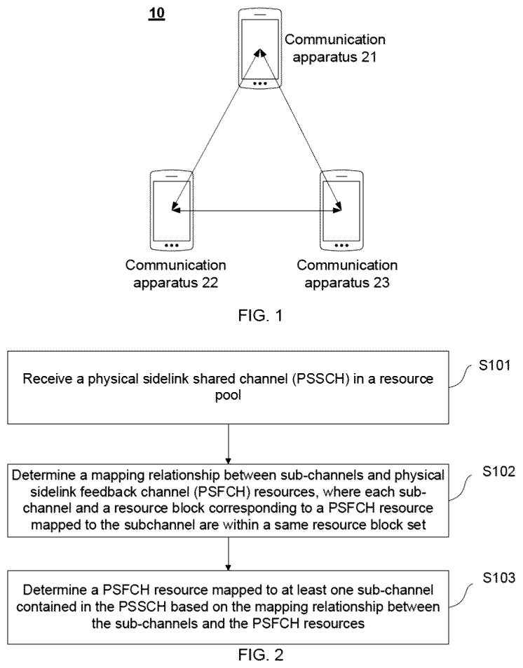

Exemplarily, FIG. 1 is a schematic diagram of an architecture of a communication system provided in the embodiments of the present disclosure, and as shown in FIG. 1, a communication system 10 includes a plurality of communication devices (e.g., a communication device 21, a communication device 22, and a communication device 23). The plurality of communication devices may be communicatively connected with each other.

Communication devices may communicate with each other via sidelink (SL), and the communication mode may include unicast, multicast and/or broadcast, etc.

In some embodiments, the communication device may be a device with a wireless transceiving function, may be deployed on land (including indoors or outdoors, handheld, worn or in-vehicle); may also be deployed on the water (e.g., on a ship, etc.); may also be deployed in the air (e.g., on an airplane, a balloon and a satellite, etc.). The communication device may be a mobile phone, a Pad, a computer with a wireless transceiving function, a virtual reality (VR) terminal, an augmented reality (AR) terminal, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, etc. The embodiments of the present disclosure do not limit the application scenarios. The communication device sometimes may also be referred to as a user, a user equipment (UE), an access terminal, a UE unit, a UE station, a mobile station, a mobile platform, a remote station, a remote terminal, a mobile device, a UE terminal, a wireless communication device, a UE agent, or a UE apparatus, etc., which is not limited to the embodiments of the present disclosure.

It should be noted that, FIG. 1 is only an exemplary framework diagram, and a number of devices and names of the various devices included in FIG. 1 are not limited, and in addition to the devices shown in FIG. 1, the communication system may also include other devices, such as a core network device.

The embodiments of the present disclosure do not limit the application scenarios. The system architectures and the service scenarios described in the embodiments of the present disclosure are provided for more clearly explaining the technical solutions of the embodiments of the present disclosure, and do not constitute a limitation on the technical solutions provided in the embodiments of the present disclosure, and the ordinary skilled in the art may know that with the evolution of the network architectures and the emergence of new service scenarios, the technical solutions provided in the embodiments of the present disclosure are also applicable to similar technical problems.

The embodiments of the present disclosure provide a resource determination method. As shown in FIG. 2, the method is performed by a first communication device, and includes the following S101 to S103.

S101, receive a physical sidelink shared channel (PSSCH) in a resource pool.

A resource pool includes at least one resource block set (Resource Block set, RB set) in the frequency domain, a resource block set of which includes at least one sub-channel and a sub-channel of which includes multiple resource blocks. The frequency domain resource in the resource pool belongs to the unlicensed spectrum.

In some embodiments, the resource pool includes a plurality of slots in the time domain and a plurality of frequency domain resource units in the frequency domain. The time-frequency resources in the resource pool is used for sidelink communication.

In some embodiments, the resource pool includes at least one bandwidth part (Bandwidth Part, BWP), each BWP includes at least one resource block set, and includes a guardband resource block (guardband RB) between the resource block sets.

In some embodiments, sub-channels contained in different resource block sets have same indexes.

In some embodiments, sub-channels with a same index contained in different resource block sets are the same sub-channel.

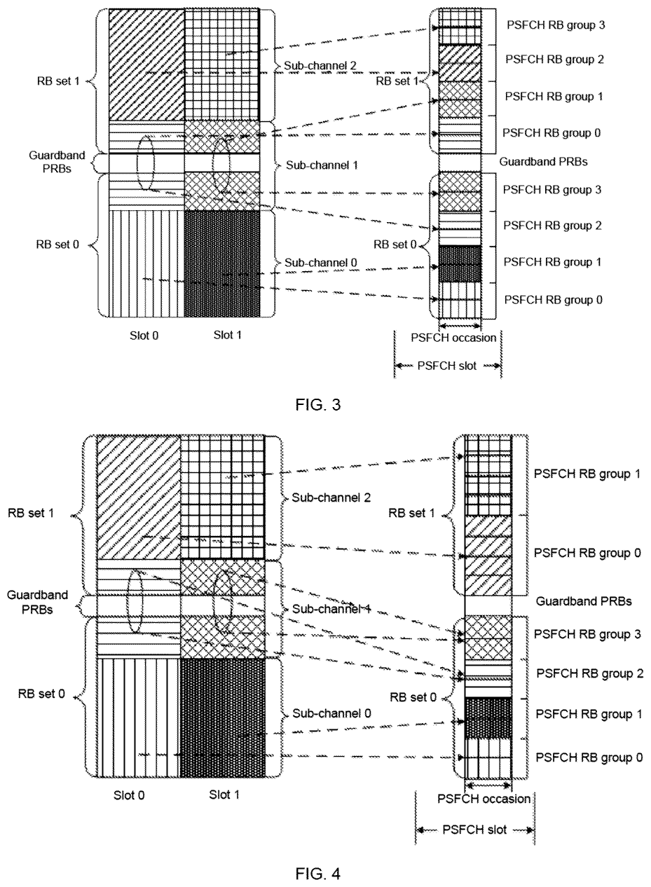

Exemplarily, as shown in FIG. 3, assuming that an index of sub-channel 1 contained in an RB set 0 is 1 and an index of a sub-channel 1 contained in an RB set 1 is also 1, then the sub-channel with the index 1 contained in the RB set 0 and the sub-channel with the index 1 contained in the RB set 1 are regarded as the same sub-channel.

In some other embodiments, sub-channels with the same index contained in different resource block sets are different sub-channels.

Exemplarily, as shown in FIG. 3, assuming that the index of the sub-channel 0 contained in the RB set 0 is 0 and the index of the sub-channel 2 contained in the RB set 1 is also 0, then the sub-channel with the index 0 contained in the RB set 0 and the sub-channel with the index 0 contained in the RB set 1 are regarded as different sub-channels.

In some other embodiments, indexes of sub-channels contained in different resource block sets are different.

Exemplarily, continuing to refer to FIG. 3, the index of the sub-channel 2 contained in the RB set 1 is 2, and the index of the sub-channel 0 contained in the RB set 0 is 0.

In some embodiments, among sub-channels contained in the PSSCH, there is at least one sub-channel that does not contain a guardband RB.

In some embodiments, a channel access process is performed on a per-channel basis.

In some other embodiments, a channel access process is performed on a per-RB set basis.

In some embodiments, in the channel access process, a channel is evaluated according to a received signal strength on the channel; when the received signal strength on the channel is less than a preset value for a certain number of times and/or for a certain duration, an evaluation result is that the channel is available, and the channel being available means that the communication device may use part or all of the frequency domain resources contained in the channel to transmit sidelink information within a period of time. A bandwidth of a channel is usually 20 MHz, and a channel includes an RB set and may also include a guardband RB. An RB set includes one or more sub-channels, a sub-channel of which includes at least one RB.

S102, determine a mapping relationship between sub-channels and physical sidelink feedback channel (PSFCH) resources, where each sub-channel and a resource block corresponding to a PSFCH resource mapped to the sub-channel are within a same resource block set.

In some embodiments, determining the mapping relationship between the sub-channels and the PSFCH resources, represents that the first communication device allocates the PSFCH resource to the sub-channel.

In some embodiments, the PSFCH resource contains a resource block (Resource Block, RB) in the frequency domain.

In some embodiments, the PSFCH resource contains a plurality of resource blocks (RBs) in the frequency domain.

In some other embodiments, the PSFCH resource contains a physical resource block (Physical Resource Block, PRB) in the frequency domain.

In some other embodiments, the PSFCH resource contains a plurality of physical resource blocks (PRBs) in the frequency domain.

In some embodiments, a resource block set including a sub-channel represents that at least one resource block among resource blocks contained in a sub-channel is contained in a resource block set.

Exemplarily, as shown in FIG. 3, all resource blocks contained in the sub-channel 0 are within the RB set 0. The sub-channel 1 contains a guardband resource block, and a part of resource blocks contained in the sub-channel 1 are within the RB set 0, and another part of the resource blocks are within the RB set 1. All resource blocks contained in the sub-channel 2 are located in the RB set 1.

Therefore, it is determined that the sub-channel 0 is contained in the RB set 0; the sub-channel 1 is contained in the RB set 0, and the sub-channel 1 is contained in the RB set 1; and the sub-channel 2 is contained in the RB set 1.

Therefore, the frequency domain of the PSFCH resource mapped to the sub-channel 0 is within the RB set 0. For the PSFCH resource mapped to the sub-channel 1, the frequency domain of a part of the PSFCH resource is within the RB set 0, and the frequency domain of another part of the PSFCH resource is within the RB set 1. The frequency domain of the PSFCH resource mapped to the sub-channel 2 is within the RB set 1. The above conclusion applies to both slot 0 and slot 1.

In some embodiments, a resource block set including a sub-channel, represents that: a first non-guardband resource block contained in a sub-channel is contained in a resource block set.

Exemplarily, as shown in FIG. 4, all resource blocks of the sub-channel 0 are contained in the RB set 0, the first non-guardband resource block of the sub-channel 1 is contained in the RB set 0, and all resource blocks of the sub-channel 2 are contained in the RB set 1.

Therefore, it is determined that the sub-channel 0 is contained in the RB set 0; the sub-channel 1 is contained in the RB set 0; and the sub-channel 2 is contained in the RB set 1.

Thus, the frequency domain of the PSFCH resource mapped to the sub-channel 0 on a slot is within the RB set 0. The frequency domain of the PSFCH resource mapped to the sub-channel 1 is within the RB set 0. The frequency domain of the PSFCH resource mapped to the sub-channel 2 is within the RB set 1. The above conclusion applies to both slot 0 and slot 1.

In some embodiments, a resource block set including a sub-channel, represents that: a last non-guardband resource block contained in a sub-channel is contained in a resource block set. In this way, it may be avoided that the sub-channel not including a guardband resource block corresponds to reduced PSFCH resources because the sub-channel including a guardband resource block corresponds to more PSFCH resources.

In some embodiments, a resource block set including a sub-channel, represents that: a first resource block contained in a sub-channel is contained in a resource block set.

In some embodiments, a resource block set including a sub-channel, represents that: a last resource block contained in a sub-channel is contained in a resource block set.

In some embodiments, a resource block set including a sub-channel, represents that: all resource blocks contained in a sub-channel are contained in a resource block set. In this way, the sub-channel containing a guardband resource block has no corresponding PSFCH resource, while a sub-channel not containing a guardband resource block corresponds to at least one PSFCH resource. This is conducive to enabling that the number of PSFCH resources mapped to a sub-channel without a guardband resource block and the number of PSFCH resources mapped to another sub-channel without a guardband resource block, are the same or have a small difference.

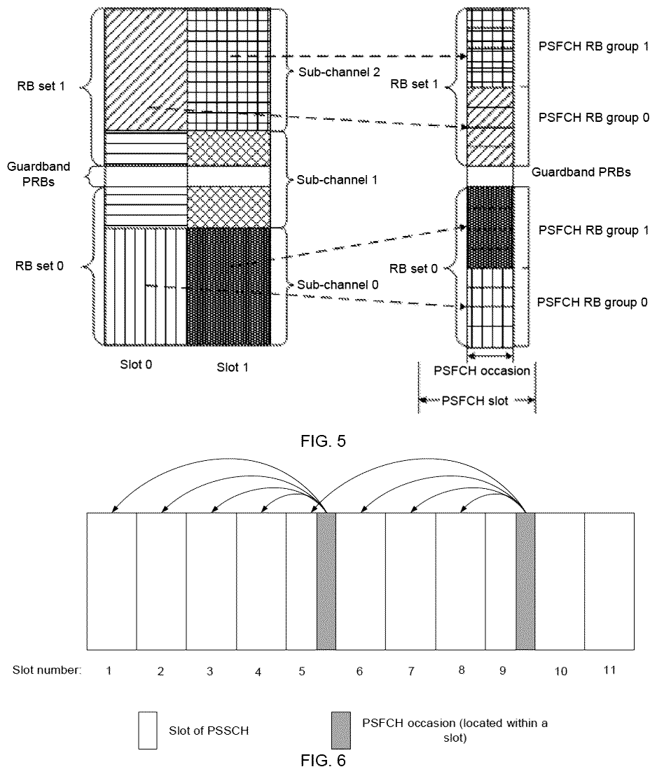

Exemplarily, as shown in FIG. 5, all resource blocks of the sub-channel 0 are contained in the RB set 0; a part of resource blocks contained in the sub-channel 1 are contained in the RB set 0, another part of the resource blocks are contained in the RB set 1; and all resource blocks of the sub-channel 2 are contained in the RB set 1.

Therefore, it is determined that the sub-channel 0 is contained in the RB set 0; the sub-channel 1 is not contained in the RB set 0, and the sub-channel 1 is also not contained in the RB set 1; and the sub-channel 2 is contained in the RB set 1.

Thus, the frequency domain of the PSFCH resource mapped to the sub-channel 0 is within the RB set 0. The frequency domain of the PSFCH resource mapped to the sub-channel 2 is within the RB set 1. The above conclusion applies to both slot 0 and slot 1.

In some embodiments, determining the mapping relationship between the sub-channels and the PSFCH resources, includes allocating the PSFCH resource to a sub-channel in a slot.

In an embodiment, a

$$[ k \cdot {M}_{subch , slot}^{PSFCH} , ( k + 1 ) \cdot {M}_{subch , slot}^{PSFCH} - 1 ] - th$$

PSFCH resource in a group of PSFCH resources is allocated or a PSFCH resource with an index

$$[ k \cdot {M}_{subch , slot}^{PSFCH} , ( k + 1 ) \cdot {M}_{subch , slot}^{PSFCH} - 1 ]$$

in a group of PSFCH resources is allocated, to a sub-channel j in a slot i, where

$$k = i + j \cdot {N}_{P S S C H}^{P S F C H} ,$$

j is a sub-channel index in a resource block set,

$${N}_{P S S C H}^{P S F C H}$$

is equal to a period of the PSFCH, and

$${M}_{s u b ch , slot}^{P S F C H}$$

is a positive integer.

In some embodiments, a PSFCH occasion is in a slot, the slot is referred to as a PSFCH slot, and a PSFCH slot is associated with

$${N}_{P S S C H}^{PSFCH}$$

PSSCH slots.

Exemplarily, an association relationship between a PSFCH slot and PSSCH slots is shown in FIG. 6. The slot of a PSSCH may also be referred to as a slot of a candidate PSSCH, which is a slot in which the PSSCH is possible to be transmitted. In FIG. 6, a period value

$${N}_{P S S C H}^{PSFCH}$$

of the PSFCH=4, and a PSFCH slot is associated with

$${N}_{P S S C H}^{PSFCH = 4}$$

PSSCH slots.

In some embodiments,

$${M}_{s u b ch , slot}^{PSFCH}$$

is the number of PSFCH resources, mapped to a sub-channel and within an RB set to which the sub-channel belongs.

In some embodiments, a PSFCH slot includes a PSFCH occasion, M_{subch, slot}^{PSFCH} is a quotient of a total number of PSFCH resources in an RB set in a PSFCH slot divided by, a product of a number of sub-channels contained in the RB set and the PSFCH period.

Exemplarily, referring to FIG. 3, a PSFCH slot includes a PSFCH occasion, a PSFCH occasion includes a plurality of time domain symbols, the total number of PSFCH resources in the RB set 0 in a PSFCH slot is 8, and the RB set 0 contains the sub-channel 0 and the sub-channel 1. The number of PSSCH slots mapped to the PSFCH slot is 2, i.e., a slot 0 and a slot 1, and the number of PSSCH slots mapped to the PSFCH slot is equal to the period value of the PSFCH. The product of the number of sub-channels contained in the RB set 0 and the PSFCH period is 4. Thus, the number of PSFCH resources, within an RB set 0 and mapped to the sub-channel 0 of the slot 0, the sub-channel 0 of the slot 1, the sub-channel 1 of the slot 0, or the sub-channel 1 of the slot 1, is 2, respectively.

Exemplarily, continuing to refer to FIG. 3, a PSFCH slot includes a PSFCH occasion, a PSFCH occasion includes a plurality of time domain symbols, a total number of PSFCH resources in the RB set 1 in a PSFCH slot is 8, and the RB set 1 contains the sub-channel 1 and the sub-channel 2. The period value of the PSFCH is 2, and the product of the number of sub-channels contained in the RB set 1 and the PSFCH period is 4, and thus the number of PSFCH resources, within an RB set 1 and mapped to the sub-channel 1 of the slot 0, the sub-channel 1 of the slot 1, the sub-channel 2 of the slot 0, or the sub-channel 2 of the slot 1, is 2, respectively.

As an example, continuing to refer to FIG. 3, the sub-channel 0 is contained in the RB set 0, the sub-channel 1 is contained in both the RB set 0 and the RB set 1, and the sub-channel 2 is contained in the RB set 1. The PSSCH slots mapped to a PSFCH slot include the slot 0 and the slot 1.

Thus, the PSFCH resources allocated to the sub-channel 0 of the slot 0 include the 0th PSFCH resource to the 1st PSFCH resource in the RB set 0. The PSFCH resources allocated to the sub-channel 0 in the slot 1 include the 2nd PSFCH resource to the 3rd PSFCH resource in the RB set 0. The PSFCH resources allocated to the sub-channel 1 in the slot 0 include the 4th PSFCH resource to the 5th PSFCH resource in the RB set 0. The PSFCH resources allocated to the sub-channel 1 in the slot 1 include the 6th PSFCH resource to the 7th PSFCH resource in the RB set 0.

As another example, referring to FIG. 4, the sub-channels of the PSSCH include the sub-channel 0, sub-channel 1, and sub-channel 2. The sub-channel 0 and sub-channel 1 are contained in the RB set 0, and the sub-channel 2 is contained in the RB set 1. The PSSCH slots mapped to a PSFCH slot/occasion contain the slot 0 and slot 1.

The PSFCH resources allocated to the sub-channel 0 of slot 0 include the 0th PSFCH resource to the 1st PSFCH resource of the RB set 0. The PSFCH resources allocated to the sub-channel 0 of the slot 1 include the 2nd PSFCH resource to the 3rd PSFCH resource in the RB set 0. The PSFCH resources allocated to the sub-channel 1 of the slot 0 include the 4th PSFCH resource to the 5th PSFCH resource of the RB set 0. The PSFCH resources allocated to the sub-channel 1 of the slot 1 include the 6th PSFCH resource to the 7th PSFCH resource of the RB set 0.

In another embodiment, a

$$[ ( k ) \cdot ( {M}_{s u b ch , slot}^{P S F C H} * K 1 ) , ( k + 1 ) \cdot ( {M}_{s u b ch , slot}^{P S F C H} * K 1 ) - 1 ] - th$$

PSFCH resource block in a group of PSFCH resource blocks is allocated or a PSFCH resource block with an index

$$[ ( k ) \cdot ( {M}_{s u b ch , slot}^{P S F C H} * K 1 ) , ( k + 1 ) \cdot ( {M}_{s u b ch , slot}^{P S F C H} * K 1 ) - 1 ]$$

in a group of PSFCH resource blocks is allocated, to a sub-channel j in a slot i, where

$$k = i + j \cdot {N}_{PSSCH}^{PSFCH} ,$$

j is a sub-channel index in a resource block set,

$${N}_{P S S C H}^{P S F C H}$$

is equal to a period of a PSFCH,

$${M}_{s u b ch , slot}^{P S F C H}$$

is a positive integer, and a PSFCH resource includes K1 PSFCH resource blocks.

Exemplarily, continuing to refer to FIG. 5, the sub-channels of the PSSCH include sub-channel 0, sub-channel 1, and sub-channel 2. The sub-channel 0 is contained in the RB set 0, and the sub-channel 2 is contained in the RB set 1. PSSCH slots mapped to a PSFCH slot/occasion contains the slot 0 and slot 1.

The PSFCH resource blocks allocated to the sub-channel 0 of the slot 0 include the 0th PSFCH resource block to the 3rd PSFCH resource block of the RB set 0. The PSFCH resource blocks allocated to the sub-channel 0 of the slot 1 include the 4th PSFCH resource block to the 7th PSFCH resource block of the RB set 0.

In some embodiments, i is the index of the slot of the PSSCH and j is the index of the sub-channel. The index of the sub-channel is used to represent a position/index of the sub-channel in a resource block set; the index of the slot of the PSSCH is used to represent a position/index of the slot of the received PSSCH in slots of the PSSCH mapped to the PSFCH slot/occasion.

In some embodiments, the index i of the slot of the PSSCH is a natural number smaller than the period of the PSFCH.

In some embodiments, the index j of the sub-channel is less than a number of sub-channels contained in the RB set to which the sub-channel belongs, and j is a natural number.

S103, determine a PSFCH resource mapped to at least one sub-channel contained in the PSSCH based on the mapping relationship between the sub-channels and the PSFCH resources.

In some embodiments, a PSFCH resource includes a resource block in the frequency domain. The resource block includes at least one of: a common resource block, a physical resource block, and a virtual resource block.

In some embodiments, in the frequency domain, for a case where a subcarrier spacing configuration is μ, the common resource blocks are numbered starting from 0. A center of subcarrier 0 of the common resource block 0 with the subcarrier spacing configuration μ coincides with a “point A”. With respect to the subcarrier spacing configuration μ, the relationship between the common resource block index

$${n}_{CRB}^{μ}$$

and resource element (k, l) in the frequency domain is as follows:

$${n}_{CRB}^{u} = \frac{k}{{N}_{s c}^{RB}}$$

herein, k is an offset with respect to the “point A”, and for example, k=0 corresponds to subcarrier centered at the “point A”.

In some embodiments, physical resource blocks with subcarrier spacing configuration μ are defined in a bandwidth part, and are numbered from 0 to

$${N}_{BWP , i}^{size , μ} - 1 ,$$

where i is the index of the bandwidth part.

The relationship between the physical resource block

$${n}_{PRB}^{u}$$

in the bandwidth part i and the common resource block

$${n}_{CRB}^{u}$$

is as follows:

$${n}_{CRB}^{μ} = {n}_{PRB}^{μ} + {N}_{BWP ,}^{start , μ}$$

herein,

$${N}_{BWP , i}^{start , μ}$$

is a common resource block that is the starting of the bandwidth part i with respect to the common resource block 0. The exponent μ may be omitted when there is no risk of confusion.

In some embodiments, the virtual resource blocks are defined in a bandwidth part, and are numbered from 0 to

$${N}_{BWP , i}^{size} - 1 ,$$

where i is the index of the bandwidth part.

In some embodiments, the PSFCH is transmitted on the PSFCH resource mapped to at least one sub-channel contained in the PSSCH. The PSFCH includes an indication for a hybrid automatic repeat request-acknowledgement (Hybrid Automatic Repeat Request-Acknowledgement, HARQ-ACK) or conflict indication information.

In some embodiments, the HARQ-ACK includes two states: ACK (Acknowledgement) and NACK (Negative Acknowledgment), or the HARQ-ACK includes only a state: NACK. The ACK represents that the PSSCH is received correctly. The NACK represents that the PSSCH is received incorrectly.

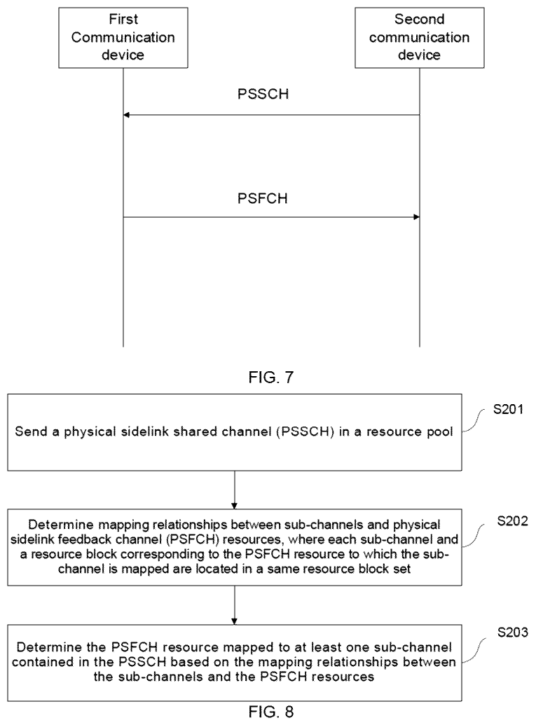

Exemplarily, FIG. 7 is a flow diagram of a communication interaction, provided in the embodiments of the present disclosure. The second communication device sends the PSSCH to the first communication device, and the second communication device receives the PSFCH sent by the first communication device, where the PSFCH is used to indicate the HARQ-ACK information or conflict indication information for the above-mentioned PSSCH.

Based on this, the first communication device receives a PSSCH, the PSSCH contains at least one sub-channel, and the PSFCH mapped to a sub-channel is within a same RB set as the sub-channel, and therefore, resources corresponding to the PSFCH sent by the first communication device are within one or more RBs in the RB set corresponding to the PSSCH, so that the transmission of the PSFCH increases the possibility of the first communication device successfully competing for an unlicensed spectrum channel and solves the issue of determining resources under the unlicensed spectrum.

The embodiments of the present disclosure provide a resource determination method. As shown in FIG. 8, the method is performed by a second communication device, and includes the following S201 to S203.

S201, send a physical sidelink shared channel (PSSCH) in a resource pool.

S202, determine a mapping relationship between sub-channels and a physical sidelink feedback channel (PSFCH) resources, where each sub-channel and a resource block corresponding to a PSFCH resource mapped to the sub-channel are within a same resource block set.

In some embodiments, a resource block set including a sub-channel, represents that: at least one resource block among resource blocks included in a sub-channel is included in the resource block set.

In some embodiments, a resource block set including a sub-channel, represents that: a first non-guardband resource block included in a sub-channel is included in the resource block set.

In some embodiments, a resource block set including a sub-channel, represents that: a last non-guardband resource block included in a sub-channel is included in the resource block set.

In some embodiments, a resource block set including a sub-channel, represents that: a first resource block included in a sub-channel is included in the resource block set.

In some embodiments, a resource block set including a sub-channel, represents that: a last resource block included in a sub-channel is included in the resource block set.

In some embodiments, a resource block set including a sub-channel, represents that: all resource blocks included in a sub-channel are included in the resource block set.

In some embodiments, determining the mapping relationship between the sub-channels and the PSFCH resources, includes allocating the PSFCH resource to a sub-channel of a slot, which includes:
allocating a

$$[ k \cdot {M}_{s ubch , slot}^{PSFCH} , ( k + 1 ) \cdot {M}_{s u b ch , slot}^{PSFCH} - 1 ] - th$$

PSFCH resource in a group of PSFCH resources or allocating a PSFCH resource with an index

$$[ k \cdot {M}_{s u bch , slot}^{PSFCH} , ( k + 1 ) \cdot {M}_{s u b ch , slot}^{PSFCH} - 1 ]$$

in a group of PSFCH resources, to a sub-channel j in a slot i, where

$$k = i + j \cdot {N}_{P S S C H}^{PSFCH} ,$$

j is a sub-channel index in a resource block set,

$${N}_{P S S C H}^{PSFCH}$$

is equal to a period of a PSFCH, and

$${M}_{s u b ch , slot}^{PSFCH}$$

is a positive integer.

In some embodiments, determining the mapping relationship between the sub-channels and the PSFCH resources, includes allocating at least one PSFCH resource block to the sub-channel of a slot, which includes:
allocating a

$$[ ( k ) \cdot ( {M}_{subch , slot}^{PSFCH} * K 1 ) , ( k + 1 ) \cdot ( {M}_{subch , slot}^{PSFCH} * K 1 ) - 1 ] - th$$

PSFCH resource block in a group of PSFCH resource blocks or allocating a PSFCH resource block with an index

$$[ ( k ) \cdot ( {M}_{subch , slot}^{PSFCH} * K 1 ) , ( k + 1 ) \cdot ( {M}_{subch , slot}^{PSFCH} * K 1 ) - 1 ]$$

in a group of PSFCH resource blocks, to a sub-channel j in a slot i, where

$$k = i + j \cdot {N}_{PSSCH}^{PSFCH} ,$$

j is a sub-channel index in a resource block set,

$${N}_{PSSCH}^{PSFCH}$$

is equal to a period of a PSFCH,

$${M}_{subch , slot}^{PSFCH}$$

is a positive integer, and a PSFCH resource includes K1 PSFCH resource blocks.

S203, determine a PSFCH resource mapped to at least one sub-channel included in the PSSCH based on the mapping relationship between the sub-channels and the PSFCH resources.

Based on this, the second communication device sends the PSSCH, and the PSFCH received by the second communication device and the sub-channel associated with the PSFCH resource are within a same RB set, so that the second communication device may perform COT sharing with the first communication device, thereby increasing the possibility of the first communication device successfully competing for an unlicensed spectrum channel, which is conducive for the first communication device to transmit the PSFCH. The issue of determining resources under the unlicensed spectrum is solved.

In some embodiments, in multicast communication, in a case where a group size of the multicast is m, for sidelink information sent by a member, receivers include m−1 members other than the member, where m is a number of members contained in the multicast.

In some embodiments, each member among members contained in the multicast has a corresponding identifier, and the identifier corresponding to each member is configured by a higher layer signaling.

In some embodiments, the higher layer signaling includes media access control (Media Access Control, MAC) information or radio resource control (Radio Resource Control, RRC) information.

In some embodiments, in the multicast communication, after a member in the multicast sends a PSSCH, other members that receive the PSSCH in the multicast, may send a PSFCH to the member that sends the PSSCH, for the PSSCH. The PSFCH includes HARQ-ACK information.

In some embodiments, a type of HARQ-ACK information includes a first type and a second type; the first type of HARQ-ACK information includes acknowledgement information or negative acknowledgement information; the second type of HARQ-ACK information only includes negative acknowledgement information. The acknowledgement information is used to indicate that the PSSCH is received correctly. The negative acknowledgement information is used to indicate that the PSSCH is received incorrectly.

In some embodiments, the type of HARQ-ACK information is determined according to the group size of the multicast and a number of PSFCH resources.

In some embodiments, in a case where the group size of the multicast is less than or equal to the number of PSFCH resources, the first type of HARQ-ACK information is selected, or the second type of HARQ-ACK information is selected.

In some embodiments, in a case where the group size of the multicast is greater than the number of PSFCH resources, the second type of HARQ-ACK information is selected.

In some embodiments, in a case where the group size of the multicast is less than or equal to the number of PSFCH resources, and the higher layer signaling provides a member index/identification number in the multicast, the first type of HARQ-ACK information is selected, or the second type of HARQ-ACK information is selected.

In some embodiments, in a case where the group size of the multicast is larger than the number of PSFCH resources and the higher layer signaling provides a member index/identification number in the multicast, the second type of HARQ-ACK information is selected.

In some embodiments, in a case where the PSFCH includes the first type of HARQ-ACK information, different members in the multicast use different PSFCH resources to send the PSFCH.

In some embodiments, in a case where the PSFCH includes the second type of HARQ-ACK information, different members in the multicast use the same PSFCH resource to send the PSFCH.

Exemplarily, in the multicast communication, the members contained in the multicast include in the bandwidth part i terminal 1, terminal 2, terminal 3 and terminal 4. The number of PSFCH resources is 4. The terminal 1 sends the same PSSCH to the terminal 2, terminal 3, and terminal 4. The terminal 2, terminal 3 and terminal 4, after receiving the PSSCH, use different PSFCH resources to send HARQ-ACK information to the terminal 1, and the HARQ-ACK information includes acknowledgement information or negative acknowledgement information.

Exemplarily, in the multicast communication, the members contained in the multicast include terminal 1, terminal 2, terminal 3 and terminal 4. The number of PSFCH resources is 2. The terminal 1 sends the same PSSCH to the terminal 2, terminal 3, and terminal 4. The terminal 2, terminal 3 and terminal 4, after receiving the PSSCH, use the same PSFCH resource to send HARQ-ACK information to the terminal 1, and the HARQ-ACK information only includes the negative acknowledgement information.

In some embodiments, a member in the multicast selects M resources for a transmission block (Transmission Block, TB), and a resource includes N sub-channels. At least one resource among the M resources is used to transmit at least one PSSCH, and a PSSCH includes N sub-channels.

In some embodiments, the number of PSFCH resources P is equal to NN×P_{subch}, P_{subch} is a positive integer, where NN is a preset value, such as NN=1; or NN is equal to the number of sub-channels contained in a PSSCH.

In some embodiments, P_{subch} is a minimum value of the number of PSFCH resources mapped to the sub-channel included in a frequency range. A frequency range includes a plurality of sub-channels, and a sub-channel is mapped to one or more PSFCH resources.

In some embodiments, a frequency range includes at least one of: a plurality of resource block sets in a resource pool, all resource block sets in a resource pool, a plurality of resource block sets in a BWP, all resource block sets in a BWP, and a resource block set.

In some embodiments, P_{subch} is configured by a higher layer signaling or determined according to pre-configuration information.

In some embodiments, the higher layer signaling includes media access control (MAC) information or radio resource control (RRC) information.

In some embodiments, the pre-configuration information is higher layer pre-configuration information. The higher layer is defined with respect to a physical layer. The configuration generally comes from the network or base station and is sent from the network or base station to the communication device via signaling. The pre-configuration is generally a configuration provided by other higher layer entities, e.g., a higher layer of the communication device itself, other network entities, etc.

In some other embodiments, the number of PSFCH resources P is equal to a minimum value among M number of Pₘ, where the Pₘ is a total of the number of PSFCH resources mapped to respective N sub-channels contained in an m-th resource among the M resources selected by a third communication device for a transmission block (TB). Or, Pₘ represents the number of PSFCH resources mapped to a first sub-channel contained in an m-th resource among M resources selected by a third user equipment (also referred to as a third communication device) for a TB.

Based on this, the problem of insufficient PSFCH capacity when the first type of HARQ-ACK information is selected may be avoided. For example, when the first type of HARQ-ACK information is selected, if the number of PSFCH resources P is less than the group size of the multicast, the problem of insufficient PSFCH capacity will occur.

The above introduces the solutions of the embodiments of the present disclosure mainly from the perspective of methods. Two types of resource determination apparatus are also shown below, which are used to perform the communication method in any one of the above embodiments and implementations thereof. It can be understood that the resource determination apparatus includes the corresponding hardware structures and/or software modules for performing various functions in order to implement the resource determination method, and those skilled in the art should easily recognize that the present disclosure can be implemented in the form of hardware or a combination of hardware and computer software, in conjunction with the algorithm steps of various examples described in the embodiments of the present disclosure. Whether a certain function is performed by hardware or computer software-driven hardware depends on the specific application and design constraints of the technical solutions. Professional technicians may use different methods to implement the described functions, for each specific application, but such an implementation should not be considered beyond the scope of the present disclosure.

In the embodiments of the present disclosure, the resource determination apparatus may be divided into functional modules according to the above-mentioned method embodiments, and for example, each functional module may be divided corresponding to each function, or two or more functions may be integrated into one functional module. The above-mentioned integrated module may be implemented in the form of hardware or may be implemented in the form of software. It should be noted that the division of modules in the embodiments of the present disclosure is illustrative, and is merely a kind of logical functional division, and there may be other division methods in actual implementations. The example in which each functional module may be divided corresponding to each function is taken for explanation below.

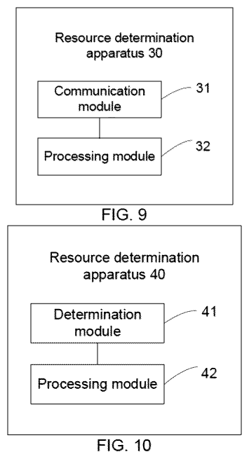

FIG. 9 is a resource determination apparatus provided in the embodiments of the present disclosure. The resource determination apparatus is applied to a first communication device. The resource determination apparatus 30 includes: a communication module 31 and a processing module 32.

The communication module 31 is configured to receive a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
the processing module 32 is configured to determine a mapping relationship between sub-channels and physical sidelink feedback channel (PSFCH) resources, where any sub-channel of the sub-channels and a resource block corresponding to a PSFCH resource mapped to the sub-channel are within a same resource block set; and
the processing module 32 is further configured to determine a PSFCH resource mapped to at least one sub-channel included in the PSSCH based on the mapping relationship between the sub-channels and the PSFCH resources.

In some embodiments, a resource block set of the at least one resource block set including a sub-channel, represents that: at least one resource block among resource blocks included in the sub-channel is included in the resource block set.

In some embodiments, a resource block set of the at least one resource block set including a sub-channel, represents that: a first non-guardband resource block included in the sub-channel is included in the resource block set.

In some embodiments, a resource block set of the at least one resource block set including a sub-channel, represents that: a last non-guardband resource block included in the sub-channel is included in the resource block set.

In some embodiments, a resource block set of the at least one resource block set including a sub-channel, represents that: a first resource block included in the sub-channel is included in the resource block set.

In some embodiments, a resource block set of the at least one resource block set including a sub-channel, represents that: a last resource block included in the sub-channel is included in the resource block set.

In some embodiments, a resource block set of the at least one resource block set including a sub-channel, represents that: all resource blocks included in the sub-channel are included in the resource block set.

In some embodiments, determining the mapping relationship between the sub-channels and the PSFCH resources, includes allocating the PSFCH resource to the sub-channel of a slot, which includes:
allocating a

$$[ k \cdot {M}_{subch , slot}^{PSFCH} , ( k + 1 ) \cdot {M}_{subch , slot}^{PSFCH} - 1 ] - th$$

PSFCH resource in a group of PSFCH resources or allocating a PSFCH resource with an index

$$[ k \cdot {M}_{subch , slot}^{PSFCH} , ( k + 1 ) \cdot {M}_{subch , slot}^{PSFCH} - 1 ]$$

in a group of PSFCH resources, to a sub-channel j in a slot i, where

$$k = i + j \cdot {N}_{PSSCH}^{PSFCH} ,$$

j is a sub-channel index in a resource block set,

$${N}_{PSSCH}^{PSFCH}$$

is equal to a period of a PSFCH, and

$${M}_{subch , slot}^{PSFCH}$$

is a positive integer.

In some embodiments, determining the mapping relationship between the sub-channels and the PSFCH resources, includes allocating at least one PSFCH resource block to the sub-channel of a slot, which includes:
allocating a

$$[ ( k ) \cdot ( {M}_{subch , slot}^{PSFCH} * K 1 ) , ( k + 1 ) \cdot ( {M}_{subch , slot}^{PSFCH} * K 1 ) - 1 ] - th$$

PSFCH resource block in a group of PSFCH resource blocks or allocating a PSFCH resource block with an index

$$[ ( k ) \cdot ( {M}_{subch , slot}^{PSFCH} * K 1 ) , ( k + 1 ) \cdot ( {M}_{subch , slot}^{PSFCH} * K 1 ) - 1 ]$$

in a group of PSFCH resource blocks, to a sub-channel j in a slot i, where

$$k = i + j \cdot {N}_{PSSCH}^{PSFCH} ,$$

j is a sub-channel index in a resource block set,

$${N}_{PSSCH}^{PSFCH}$$

is equal to a period of a PSFCH,

$${M}_{subch , slot}^{PSFCH}$$

is a positive integer, and the PSFCH resource includes K1 PSFCH resource blocks.

FIG. 10 is a resource determination apparatus provided by the embodiments of the present disclosure. The resource determination apparatus is applied to a second communication device. The resource determination apparatus 40 includes: a communication module 41 and a processing module 42.

The communication module 41 is configured to send a physical sidelink shared channel (PSSCH) in a resource pool; where the resource pool includes at least one resource block set in a frequency domain, each resource block set of the at least one resource block set includes at least one sub-channel, and each sub-channel of the at least one sub-channel includes multiple resource blocks;
the processing module 42 is configured to determine a mapping relationship between sub-channels and physical sidelink feedback channel (PSFCH) resources, where any sub-channel of the sub-channels and a resource block corresponding to a PSFCH resource mapped to the sub-channel are within a same resource block set; and
the processing module 42 is further configured to determine a PSFCH resource mapped to at least one sub-channel included in the PSSCH based on the mapping relationship between the sub-channels and the PSFCH resources.

In some embodiments, a resource block set of the at least one resource block set including a sub-channel, represents that: at least one resource block among resource blocks included in the sub-channel is included in the resource block set.

In some embodiments, a resource block set of the at least one resource block set including a sub-channel, represents that: a first non-guardband resource block included in the sub-channel is included in the resource block set.

In some embodiments, a resource block set of the at least one resource block set including a sub-channel, represents that: a last non-guardband resource block included in the sub-channel is included in the resource block set.

In some embodiments, a resource block set of the at least one resource block set including a sub-channel, represents that: a first resource block included in the sub-channel is included in the resource block set.

In some embodiments, a resource block set of the at least one resource block set including a sub-channel represents that: a last resource block included in the sub-channel is included in the resource block set.

In some embodiments, a resource block set of the at least one resource block set including a sub-channel, represents that: all resource blocks included in the sub-channel are included in the resource block set.

In some embodiments, determining the mapping relationship between the sub-channels and the PSFCH resources, includes allocating the PSFCH resource to the sub-channel of a slot, which includes:
allocating a

$$[ k \cdot {M}_{subch , slot}^{PSFCH} , ( k + 1 ) \cdot {M}_{subch , slot}^{PSFCH} - 1 ] - th$$

PSFCH resource in a group of PSFCH resources or allocating a PSFCH resource with an index

$$[ k \cdot {M}_{subch , slot}^{PSFCH} , ( k + 1 ) \cdot {M}_{subch , slot}^{PSFCH} - 1 ]$$

in a group of PSFCH resources, to a sub-channel j in a slot i, where

$$k = i + j \cdot {N}_{PSSCH}^{PSFCH} ,$$

j is a sub-channel index in a resource block set,

$${N}_{PSSCH}^{PSFCH}$$

is equal to a period of a PSFCH, and

$${M}_{subch , slot}^{PSFCH}$$

is a positive integer.

In some embodiments, determining the mapping relationship between the sub-channels and the PSFCH resources, includes allocating at least one PSFCH resource block to the sub-channel of a slot, which includes:
allocating a

$$[ ( k ) \cdot ( {M}_{subch , slot}^{PSFCH} , ( K 1 ) , ( k + 1 ) \cdot ( {M}_{subch , slot}^{PSFCH} * K 1 ) - 1 ] - th$$

PSFCH resource block in a group of PSFCH resource blocks or allocating a PSFCH resource block with an index

$$[ ( k ) \cdot ( {M}_{subch , slot}^{PSFCH} , ( K 1 ) , ( k + 1 ) \cdot ( {M}_{subch , slot}^{PSFCH} * K 1 ) - 1 ]$$

in a group of PSFCH resource blocks, to a sub-channel j in a slot i, where

$$k = i + j \cdot {N}_{PSSCH}^{PSFCH} ,$$

j is a sub-channel index in a resource block set,

$${N}_{PSSCH}^{PSFCH}$$

is equal to a period of a PSFCH,

$${M}_{subch , slot}^{PSFCH}$$

is a positive integer, and the PSFCH resource includes K1 PSFCH resource blocks.

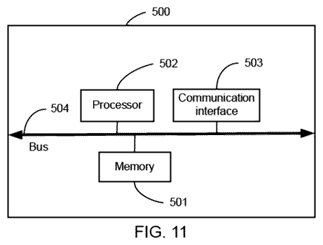

In a case where the functions of the above integrated modules are implemented in the form of hardware, the embodiments of the present disclosure further provide a structure of a communication apparatus, and the communication apparatus is configured to perform the resource determination method provided in the embodiments of the present disclosure. As shown in FIG. 11, the communication apparatus 500 includes a memory 501, a processor 502, a communication interface 503 and a bus 504.

The memory 501 may be, but not limited to, a read-only memory (ROM) or other types of static storage devices capable of storing static information and instructions, a random access memory (RAM) or other types of dynamic storage devices capable of storing dynamic information and instructions, or may also be an electrically erasable programmable read-only memory (EEPROM), a magnetic disk storage medium or other magnetic storage devices, or any other medium capable of being used to carry or store the desired program codes in the form of instructions or data structures and capable of being accessed by a computer.

The processor 502 may implement or perform various exemplary logical blocks, modules and circuits described in conjunction with the embodiments of the present disclosure. The processor 502 may be a central processing unit, a general-purpose processor, a digital signal processor, an application specific integrated circuit, a field programmable gate array or other programmable logic devices, a transistor logic device, a hardware component or any combination thereof. The processor 502 may implement or perform various exemplary logical blocks, modules and circuits described in conjunction with the embodiments of the present disclosure. The processor 502 may also be a combination that implements computing functions, for example, including a combination of one or more microprocessors, a combination of a digital signal processor (DSP) and a microprocessor, or the like.

The communication interface 503 is configured to connect with other devices via a communication network. The communication network may be an Ethernet, a radio access network, a wireless local area network (WLAN), or the like.

In an embodiment, the memory 501 may be separated from the processor 502, and the memory 501 may be connected to the processor 502 via the bus 504 and is configured to store instructions or program codes. The processor 502, when calling and executing the instructions or program codes stored in the memory 501, is capable of implementing the resource determination method, provided in the embodiments of the present disclosure.

In another embodiment, the memory 501 may also be integrated with the processor 502.

The bus 504 may be an extended industry standard architecture (EISA) bus or the like. Buses 504 may be divided into address buses, data buses, control buses, and the like. For the convenience of representation, only one thick line is used in FIG. 11 for representation, but it does not mean that there is only one bus or one type of bus.

Some embodiments of the present disclosure provide a computer readable storage medium (e.g., a non-transitory computer readable storage medium), and the computer-readable storage medium has stored computer program instructions therein that, when running on a computer, cause the computer to perform the resource determination method as described in any embodiment of the above-mentioned embodiments.

In an exemplary implementation, the computer may be the above-mentioned communication apparatus, and the present disclosure does not limit the specific form of the computer.

In some examples, the above-mentioned computer readable storage medium may include, but be not limited to, a magnetic storage device (e.g., a hard disk, a floppy disk or a magnetic tape, etc.), an optical disk (e.g., a Compact Disk (CD) or a Digital Versatile Disk (DVD), etc.), a smart card and a flash memory device (e.g., an Erasable Programmable Read-Only Memory (EPROM), a card, a stick or a key driver, etc.). The various computer-readable storage media described in the present disclosure may represent one or more devices and/or other machine-readable storage media for storing information. The term “machine-readable storage medium” may include, but be not limited to, a radio channel and various other media capable of storing, containing, and/or carrying instructions and/or data.

The embodiments of the present disclosure provide a computer program product containing instructions, and the computer program product, when running on a computer, causes the computer to perform the resource determination method as described in any embodiment of the above-mentioned embodiments.

The aforementioned descriptions are merely specific implementations of the present disclosure, but the protection scope of the present disclosure is not limited thereto, and any changes or substitutions within the scope of the technologies disclosed in the present disclosure should be covered within the protection scope of the present disclosure. Therefore, the protection scope of the present disclosure should be based on the protection scope of claims.

What is claimed is:

1. A resource determination method, performed by a first communication device, wherein the method comprises:
receiving a physical sidelink shared channel (PSSCH) in a resource pool; wherein the resource pool comprises at least one resource block set in a frequency domain, each resource block set of the at least one resource block set comprises at least one sub-channel, and each sub-channel of the at least one sub-channel comprises multiple resource blocks;
determining a mapping relationship between sub-channels and physical sidelink feedback channel (PSFCH) resources, wherein the each sub-channel and a resource block corresponding to a PSFCH resource mapped to the sub-channel are within a same resource block set; and
determining a PSFCH resource mapped to at least one sub-channel comprised in the PSSCH based on the mapping relationship between the sub-channels and the PSFCH resources.

2. The method according to claim 1, wherein a resource block set of the at least one resource block set comprising a sub-channel, represents that:
at least one resource block among resource blocks comprised in the sub-channel is comprised in the resource block set.

3. The method according to claim 1, wherein a resource block set of the at least one resource block set comprising a sub-channel, represents that:
a first non-guardband resource block comprised in the sub-channel is comprised in the resource block set.

4. The method according to claim 1, wherein a resource block set of the at least one resource block set comprising a sub-channel, represents that:
a last non-guardband resource block comprised in the sub-channel is comprised in the resource block set.

5. The method according to claim 1, wherein a resource block set of the at least one resource block set comprising a sub-channel, represents that:
a first resource block comprised in the sub-channel is comprised in the resource block set.

6. The method according to claim 1, wherein a resource block set of the at least one resource block set comprising a sub-channel, represents that:
a last resource block comprised in the sub-channel is comprised in the resource block set.

7. The method according to claim 1, wherein a resource block set of the at least one resource block set comprising a sub-channel, represents that:
all resource blocks comprised in the sub-channel are comprised in the resource block set.

8. The method according to claim 1, wherein determining the mapping relationship between the sub-channels and the PSFCH resources, comprises allocating the PSFCH resource to the sub-channel of a slot, which comprises:
allocating a
$$[ k \cdot {M}_{subch , slot}^{PSFCH} , ( k + 1 ) \cdot {M}_{subch , slot}^{PSFCH} - 1 ] - th$$
PSFCH resource in a group of PSFCH resources or allocating a PSFCH resource with an index
$$[ k \cdot {M}_{subch , slot}^{PSFCH} , ( k + 1 ) \cdot {M}_{subch , slot}^{PSFCH} - 1 ]$$
in a group of PSFCH resources, to a sub-channel j in a slot i, wherein
$$k = i + j \cdot {N}_{PSSCH}^{PSFCH} ,$$
j is a sub-channel index in a resource block set,
$${N}_{PSSCH}^{PSFCH}$$
is equal to a period of a PSFCH, and
$${M}_{subch , slot}^{PSFCH}$$
is a positive integer.

9. The method according to claim 1, wherein determining the mapping relationship between the sub-channels and the PSFCH resources, comprises allocating at least one PSFCH resource block to the sub-channel of a slot, which comprises:
allocating a
$$[ ( k ) \cdot ( {M}_{subch , slot}^{PSFCH} * K 1 ) , ( k + 1 ) \cdot ( {M}_{subch , slot}^{PSFCH} * K 1 ) - 1 ] - th$$
PSFCH resource block in a group of PSFCH resource blocks or allocating a PSFCH resource block with an index
$$[ ( k ) \cdot ( {M}_{subch , slot}^{PSFCH} * K 1 ) , ( k + 1 ) \cdot ( {M}_{subch , slot}^{PSFCH} * K 1 ) - 1 ]$$
in a group of PSFCH resource blocks, to a sub-channel j in a slot i, wherein
$$k = i + j \cdot {N}_{PSSCH}^{PSFCH} ,$$
j is a sub-channel index in a resource block set,
$${N}_{PSSCH}^{PSFCH}$$
is equal to a period of a PSFCH,
$${M}_{subch , slot}^{PSFCH}$$
is a positive integer, and the PSFCH resource comprises K1 PSFCH resource blocks.

10. A resource determination method, performed by a second communication device, wherein the method comprises:
sending a physical sidelink shared channel (PSSCH) in a resource pool; wherein the resource pool comprises at least one resource block set in a frequency domain, each resource block set of the at least one resource block set comprises at least one sub-channel, and each sub-channel of the at least one sub-channel comprises multiple resource blocks;
determining a mapping relationship between sub-channels and physical sidelink feedback channel (PSFCH) resources, wherein the each sub-channel and a resource block corresponding to a PSFCH resource mapped to the sub-channel are within a same resource block set; and
determining the PSFCH resource mapped to at least one sub-channel comprised in the PSSCH based on the mapping relationship between the sub-channels and the PSFCH resources.

11. The method according to claim 10, wherein a resource block set of the at least one resource block set comprising a sub-channel, represents that:
at least one resource block among resource blocks comprised in the sub-channel is comprised in the resource block set.

12. The method according to claim 10, wherein a resource block set of the at least one resource block set comprising a sub-channel, represents that:
a first non-guardband resource block comprised in the sub-channel is comprised in the resource block set.

13. The method according to claim 10, wherein a resource block set of the at least one resource block set comprising a sub-channel, represents that:
a last non-guardband resource block comprised in the sub-channel is comprised in the resource block set.

14. The method according to claim 10, wherein a resource block set of the at least one resource block set comprising a sub-channel, represents that:
a first resource block comprised in the sub-channel is comprised in the resource block set.

15. The method according to claim 10, wherein a resource block set of the at least one resource block set comprising a sub-channel, represents that:
a last resource block comprised in the sub-channel is comprised in the resource block set.

16. The method according to claim 10, wherein a resource block set of the at least one resource block set comprising a sub-channel, represents that:
all resource blocks comprised in the sub-channel are comprised in the resource block set.

17. The method according to claim 10, wherein determining the mapping relationship between the sub-channels and the PSFCH resources, comprises allocating the PSFCH resource to the sub-channel of a slot, which comprises:
allocating a
$$[ k \cdot {M}_{subch , slot}^{PSFCH} , ( k + 1 ) \cdot {M}_{subch , slot}^{PSFCH} - 1 ] - th$$
PSFCH resource in a group of PSFCH resources or allocating a PSFCH resource with an index
$$[ k \cdot {M}_{subch , slot}^{PSFCH} , ( k + 1 ) \cdot {M}_{subch , slot}^{PSFCH} - 1 ]$$
in a group of PSYCH resources, to a sub-channel j in a slot i, wherein
$$k = i + j \cdot {N}_{PSSCH}^{PSFCH} ,$$
j is a sub-channel index in a resource block set,
$${N}_{PSSCH}^{PSFCH}$$
is equal to a period of a PSFCH, and
$${M}_{subch , slot}^{PSFCH}$$
is a positive integer.

18. The method according to claim 10, wherein determining the mapping relationship between the sub-channels and the PSFCH resources, comprises allocating at least one PSFCH resource block to the sub-channel of a slot, which comprises:
allocating a
$$[ ( k ) \cdot ( {M}_{subch , slot}^{PSFCH} * K 1 ) , ( k + 1 ) \cdot ( {M}_{subch , slot}^{PSFCH} * K 1 ) - 1 ] - th$$
PSFCH resource block in a group of PSFCH resource blocks or allocating a PSFCH resource block with an index
$$[ ( k ) \cdot ( {M}_{subch , slot}^{PSFCH} * K 1 ) , ( k + 1 ) \cdot ( {M}_{subch , slot}^{PSFCH} * K 1 ) - 1 ]$$
in a group of PSFCH resource blocks, to a sub-channel j in a slot i, wherein
$$k = i + j \cdot {N}_{PSSCH}^{PSFCH} ,$$
j is a sub-channel index in a resource block set,
$${N}_{PSSCH}^{PSFCH}$$
is equal to a period of a PSFCH,
$${M}_{subch , slot}^{PSFCH}$$
is a positive integer, and the PSFCH resource comprises K1 PSFCH resource blocks.

19. A communication apparatus, comprising: a memory and a processor; wherein the memory is coupled with the processor; the memory is configured to store instructions executable by the processor; and the processor, when executing the instructions, performs operations of:
receiving a physical sidelink shared channel (PSSCH) in a resource pool; wherein the resource pool comprises at least one resource block set in a frequency domain, each resource block set of the at least one resource block set comprises at least one sub-channel and each sub-channel of the at least one sub-channel comprises multiple resource blocks;
determining a mapping relationship between sub-channels and physical sidelink feedback channel (PSFCH) resources, wherein the each sub-channel and a resource block corresponding to a PSFCH resource mapped to the sub-channel are within a same resource block set; and
determining a PSFCH resource mapped to at least one sub-channel comprised in the PSSCH based on the mapping relationship between the sub-channels and the PSFCH resources.

20. A non-transitory computer readable storage medium, wherein the computer readable storage medium has stored computer instructions thereon, and the computer instructions, when executed on a communication apparatus, cause the communication apparatus to perform the resource determination method according to claim 1.
